(19) United States
(12) Patent Application Publication
(10) Pub. No.: US 2009/0015558 A1
(43) Pub. Date: Jan. 15, 2009

(54) Mouse capable of detecting a pulse

(76) Inventor: Chin-Yeh Hung, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/822,879

(22) Filed: Jul. 11, 2007

(51) Int. Cl. G06F 3/033

(52) U.S. Cl. 345/163

(57) ABSTRACT

A mouse capable of detecting a pulse includes: a) a housing having electronic elements therein for fulfilling the functions of the conventional mouse, an infrared pulse sensor being disposed at the internal side of the housing for detecting the change of a slight amount of blood within the blood vessel of a user's thumb that is caused by the pulsation such that the pulse signal of the user is available; b) a control switch disposed at the internal side of the housing for turning on or off the infrared pulse sensor; c) a noise canceling circuit and a filtering shaping amplifying circuit coupled to the pulse sensor; and d) a microprocessor adapted to calculate the number of the heartbeat according to the pulse signal inputted by the filtering shaping amplifying circuit, the heartbeat signal being transmittable from a signal output terminal to a signal input terminal of a computer. Accordingly, the heartbeat signal is then received by a central processing unit (CPU) of the computer so that the user's physiological state is displayable on a display.

### BACKGROUND OF THE INVENTION

1. Field of the Invention

The invention relates to a mouse capable of detecting a pulse, and more particularly to a mouse that employs an infrared sensor for a synchronic detection of user's pulse during operation of the mouse. Meanwhile, the heartbeat state can be displayed by means of a computer.

2. Description of the Related Art

With the rapid development of the computer industry, the computer has become one of the indispensable tools in our daily life. In addition to the keyboard, the mouse is also an indispensable tool for a normal operation of the computer.

The cardiovascular disease has become a more and more serious problem for the modern people since they work in front of the computer for a long time and lack exercise. It would be a good idea if a synchronic detection of the pulse value takes place during the operation of the mouse and the physiological state can be recorded and displayed by means of the computer.

A prior invention discloses a mouse with a light-sensitive unit for receiving the indoor light signal penetrating through the fingers of the human body. Accordingly, the luminance of indoor light is available for the calculation of the current pulse value of the user. However, this detection way requires indoor light signal penetrating through the fingers of the human body to obtain the light signal. Therefore, the operation is impractical. Meanwhile, the accuracy is easily affected by the external light. Accordingly, this conventional mouse requires further improvement.

### SUMMARY OF THE INVENTION

It is a primary object of the invention to provide a mouse capable of detecting a pulse that does not affect the normal operation of the mouse. Meanwhile, a synchronic detection of the change of the slight amount of blood within the blood vessel caused by the pulsation is achieved during the normal operation of the mouse. Accordingly, the user's pulse value is available by detection.

It is another object of the invention to provide a mouse capable of detecting a pulse that employs an infrared heartbeat sensor to carry out an ergonomic and comfortable detection on the finger of the human body. Therefore, a practical operation is achieved without being affected by external light. Meanwhile, a more accurate measurement is ensured.

In order to achieve the above-mentioned objects, a mouse capable of detecting a pulse includes:

a) a housing having electronic elements therein for fulfilling the functions of the conventional mouse, an infrared pulse sensor being disposed at the internal side of the housing for detecting the change of a slight amount of blood within the blood vessel of a user's thumb that is caused by the pulsation such that the pulse signal of the user is available;

b) a control switch disposed at the internal side of the housing for turning on or off the infrared pulse sensor;

c) a noise canceling circuit and a filtering shaping amplifying circuit coupled to the pulse sensor; and

d) a microprocessor adapted to calculate the number of the heartbeat according to the pulse signal inputted by the filtering shaping amplifying circuit, the heartbeat signal being transmittable from a signal output terminal to a signal input terminal of a computer,

whereby the heartbeat signal is then received by a central processing unit (CPU) of the computer so that the user's physiological state is displayable on a display.

### BRIEF DESCRIPTION OF THE FIGURES

The accomplishment of this and other objects of the invention will become apparent from the following descriptions and its accompanying figures of which:

FIG. 1 is a perspective view of an embodiment of the invention;

FIG. 2 is a side view of the embodiment of the invention;

FIG. 3 is a block diagram of the circuit of the mouse in accordance with the invention;

FIG. 4 is a perspective view of an application example of the mouse in accordance with the invention; and

FIG. 5 is a perspective view of another application example of the mouse in accordance with the invention;

### DETAILED DESCRIPTION OF THE PREFERRED EMBODIMENT

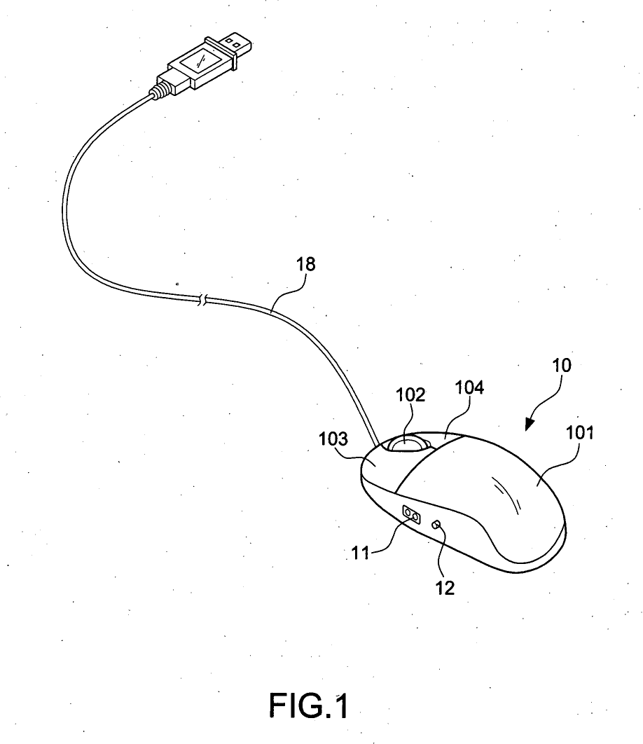

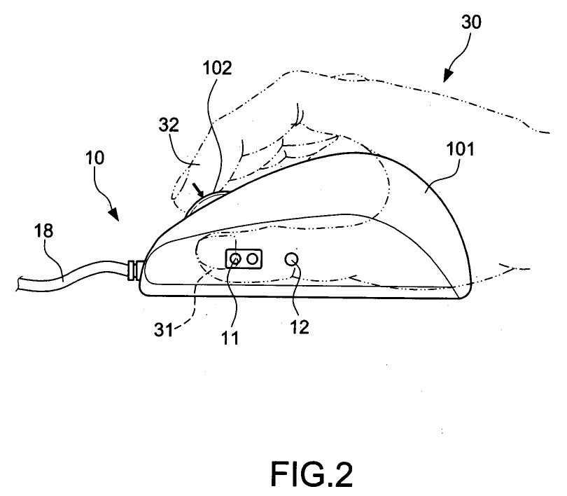

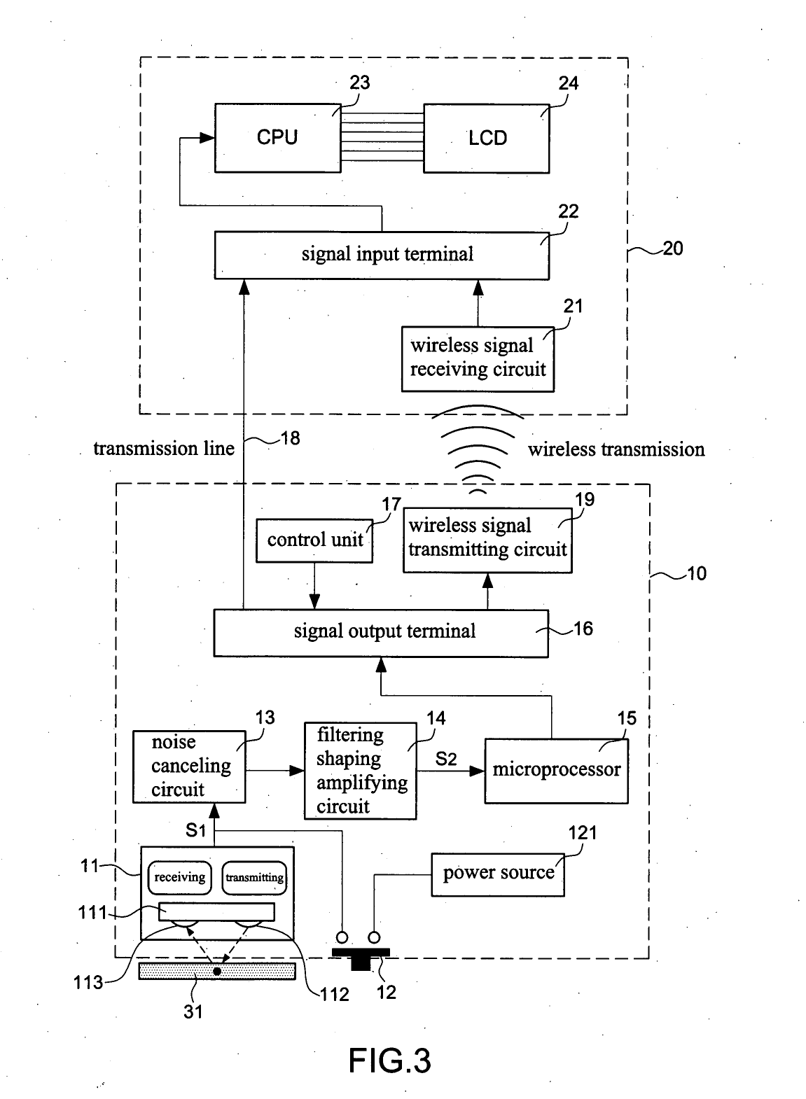

First of all, referring to FIGS. 1 through 3, a mouse 10 in accordance with a preferred embodiment of the invention includes a housing 101 in which electronic elements for fulfilling the functions of the conventional mouse are installed. They are not the object of the invention so that no further descriptions thereto are given hereinafter. The mouse according to the invention is characterized in that an infrared pulse sensor 11 is disposed at the internal side of the mouse 10. As shown in FIGS. 2 and 3, the infrared pulse sensor 11 includes an infrared transmitting unit 112 on a control circuit board 111. In approaching the thumb 31 of a hand 30 to the infrared pulse sensor 11, the infrared transmitted will be blocked by the thumb 31 such that a reflection the infrared takes place. In this way, the infrared can be received by a receiving unit 113 arranged in parallel to the infrared transmitting unit 112. Meanwhile, the change of a slight amount of blood within the blood vessel of the thumb 31 caused by the pulsation can be detected such that the pulse signal of the user is available. This pulse signal is an impulse signal S1, that is, a weak analog signal.

The above-mentioned impulse signal S1 must pass through a noise canceling circuit 13 and a filtering shaping amplifying circuit 14 to be converted into a digital signal S2 made available by a microprocessor 15. The microprocessor 15 can calculate the corresponding frequency according to the digital signal S2 such that the number of the heartbeat in a minute is available. The heartbeat signal will then be transmitted from a signal output terminal 16 to a signal input terminal 22 of a computer 20. At this time, the central processing unit 23 of the computer 20 receives the heartbeat signal. Meanwhile, the user's physiological state represented by a pulse change chart or heartbeat value is displayed on a display 24.

According to the invention, a control switch 12 is disposed at the internal side of the housing 101 for turning on or off the infrared pulse sensor 11. As shown in FIGS. 2 and 3, the control switch 12 is positioned at the flank of the infrared pulse sensor 11, but should not be restricted thereto. Accordingly, the control switch 12 can be touched when the thumb 31 approaches to the infrared pulse sensor 11, thereby establishing a closed circuit for the power source 121 and actuating the infrared pulse sensor 11. Moreover, the control switch 12 is turned off to disconnected the power source 121 when the thumb 31 is released. In this way, the infrared pulse sensor 11 is stopped for the detection process, thereby reducing the power consumption. In this embodiment, the control switch 12 is preferably a sensitive switch, but should not be restricted thereto.

As shown in FIG. 3, the mouse 10 further includes a control unit 17 consisting of a scroll wheel 102, a left button 103, and a right button 104 on the top surface of the housing 101 (see FIGS. 1 and 2) for transmitting a control signal from the signal output terminal 16 to the computer 20 so as to achieve the cursor displacement and the command execution of the computer 20.

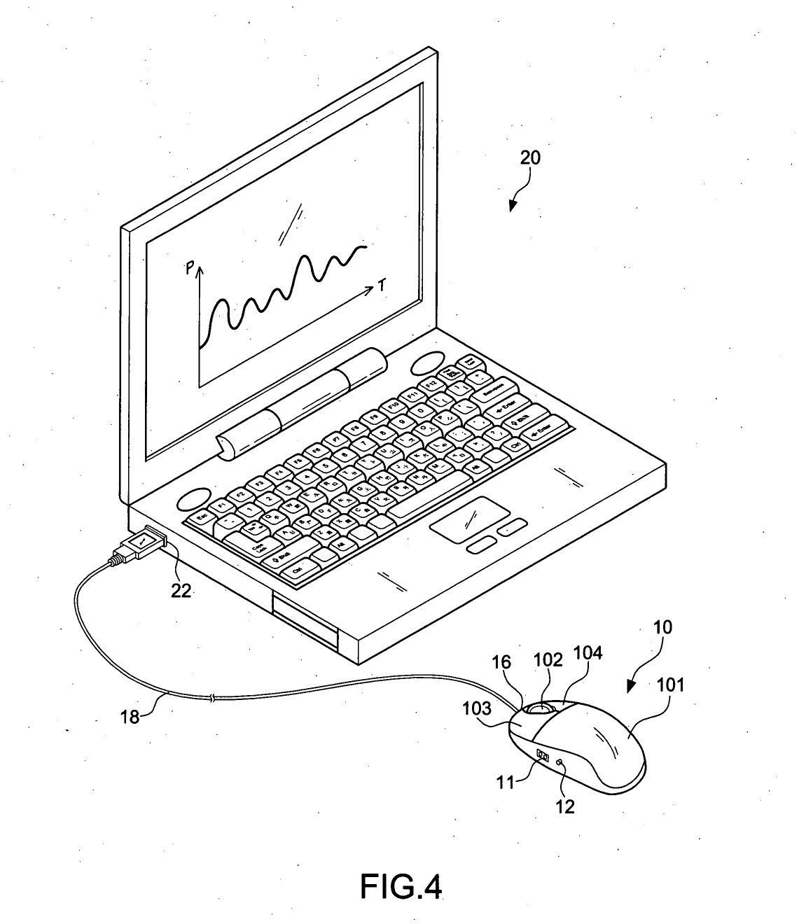

In addition, a transmission line 18 is coupled at the signal output terminal 16 and the signal input terminal 22 for performing the wire signal transmission between the mouse 10 and the computer 20 (see FIGS. 1, 3, and 4).

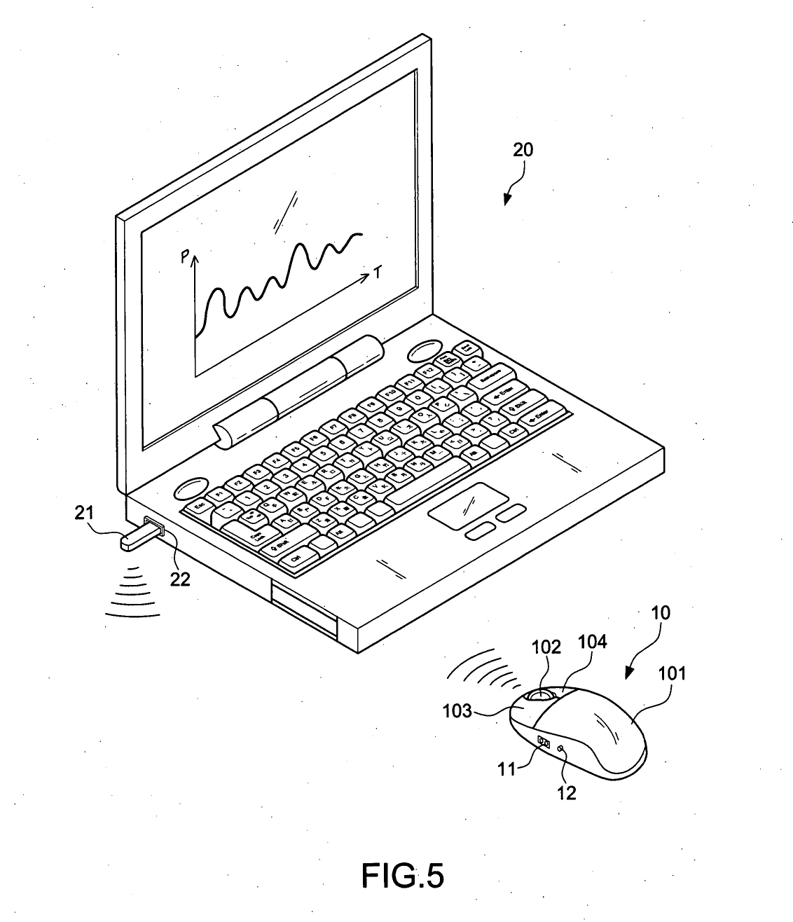

Of course, the signal transmission can be a wireless transmission type. As shown in FIGS. 3 and 5, the signal output terminal 16 of the mouse 10 is coupled to a wireless signal transmitting circuit 19 while the signal input terminal 22 of the computer 20 is coupled to a wireless signal receiving circuit 21. In this way, the detected heartbeat signal can be wirelessly transmitted to the computer 20.

Based upon the above-mentioned means, the mouse in accordance with the invention can achieve the following effects:

1. The infrared pulse sensor 11 of the invention has only few millimeters and is therefore fitted to the internal side of the housing 101 without affecting the normal functions of the mouse 10. As shown in FIG. 2, the user employs his forefinger to operate the scroll wheel 102, the left button 103 and the right button 104, and the thumb 31 is just positioned on the infrared pulse sensor 11. When the control switch 12 is actuated by an inward compression action of the thumb 31, the pulse of the finger can be detected. Therefore, the detection of the heartbeat can be done during the normal operation of the mouse 10, thereby avoiding the unnecessary time waste. After the detection process, the control unit 17 enables the computer 20 to display the user's physiological state. Meanwhile, the existing central processing unit 23 of the computer 20 can serve as a database for saving the record of the user's physiological state. Accordingly, a practical comparison and application can be achieved.

2. The pulse detection by approaching the thumb 31 of the hand 30 to the infrared pulse sensor 11 can be achieved in a manner of reflection. Therefore, the detection process won't be interfered or affected by the external light source, thereby achieving a more accurate measurement of the heartbeat value.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A mouse capable of detecting a pulse and adapted for use in cooperation with a signal input terminal of a computer, comprising:
a) a housing having electronic elements therein for fulfilling the functions of the conventional mouse, an infrared pulse sensor being disposed at the internal side of the housing for detecting the change of a slight amount of blood within the blood vessel of a user's thumb that is caused by the pulsation such that the pulse signal of the user is available;
b) a control switch disposed at the internal side of the housing for turning on or off the infrared pulse sensor;
c) a noise canceling circuit and a filtering shaping amplifying circuit coupled to the pulse sensor; and
d) a microprocessor adapted to calculate the number of the heartbeat according to the pulse signal inputted by the filtering shaping amplifying circuit, the heartbeat signal being transmittable from a signal output terminal to a signal input terminal of a computer;
whereby the heartbeat signal is then received by a central processing unit (CPU) of the computer so that the user's physiological state is displayable on a display.

2. The mouse capable of detecting a pulse as recited in claim 1 wherein a transmission line is coupled at the signal output/input terminal for performing a wire signal transmission between the mouse and the computer.

3. The mouse capable of detecting a pulse as recited in claim 1 wherein the signal transmission between the mouse and the computer is a wireless transmission type, and wherein the signal output terminal of the mouse is coupled to a wireless signal transmitting circuit while the signal input terminal of the computer is coupled to a wireless signal receiving circuit.

4. The mouse capable of detecting a pulse as recited in claim 1 wherein the mouse further includes a control unit for transmitting a control signal from the signal output terminal to the computer.

5. The mouse capable of detecting a pulse as recited in claim 1 wherein the pulse sensor includes an infrared transmitting unit disposed on a control circuit board and a receiving unit arranged in parallel thereto.
